(19) United States
(12) Patent Application Publication
(10) Pub. No.: US 2015/0261949 A1
(43) Pub. Date: Sep. 17, 2015

(54) ELECTRONIC APPARATUS AND AUTHENTICATION METHOD

(71) Applicant: Kabushiki Kaisha Toshiba, Tokyo (JP)

(72) Inventor: Tomotaka Mori, Tachikawa Tokyo (JP)

(21) Appl. No.: 14/533,456

(22) Filed: Nov. 5, 2014

(30) Foreign Application Priority Data
Mar. 14, 2014 (JP) 2014-051116

(51) Int. Cl. G06F 21/44; G06F 21/31

(52) U.S. Cl. CPC G06F 21/44; G06F 21/31

(57) ABSTRACT

According to one embodiment, an electronic apparatus sets a first password corresponding to a first input method and a second password corresponding to a second input method. The apparatus performs authentication processing for determining whether a password input by the first input method or the second input method is correct by comparing the password with a registered password. The apparatus determines which of the first input method and the second input method is used, and changes the registered password either to the first password or to the second password based on a result of the determination of the input method.

### CROSS-REFERENCE TO RELATED APPLICATIONS

This application is based upon and claims the benefit of priority from Japanese Patent Application No. 2014-051116, filed Mar. 14, 2014, the entire contents of which are incorporated herein by reference.

### FIELD

Embodiments described herein relate generally to a technique for performing authentication processing using a password.

### BACKGROUND

In recent years, various electronic devices such as notebook (laptop) computers, tablet computers and smartphones have been developed. These electronic devices are widely utilized for viewing or editing electronic documents, databases and various other types of digital content.

Also, recently, various authentication systems are utilized to improve security. A number of authentication systems compare a password input by the user with a preset password to confirm validity of the user.

In general, the longer the preset password is, the higher the security can be.

However, always using a long password may lead to more time being spent typing the password. The long password also may increase the probability of incorrect input. Since a password needs to be re-input every time it is incorrectly input, increase of incorrect input increases the time for password authentication.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating an outer appearance of an electronic apparatus according to an embodiment.

FIG. 2 illustrates an example of a relationship between the electronic apparatus and a physical keyboard according to the embodiment.

FIG. 3 illustrates another example of the relationship between the electronic apparatus and the physical keyboard according to the embodiment.

FIG. 4 is an exemplary block diagram illustrating a system configuration of the electronic apparatus according to the embodiment.

FIG. 5 illustrates an example of a key arrangement of a physical keyboard used in the electronic apparatus according to the embodiment.

FIG. 6 illustrates an example of a key arrangement of a software keyboard used in the electronic apparatus according to the embodiment.

FIG. 7 illustrates another example of the key arrangement of the software keyboard used in the electronic apparatus according to the embodiment.

FIG. 8 illustrates a plurality of passwords and a plurality of types of access rights, each of which is associated with a plurality of input methods used in the electronic apparatus according to the embodiment.

FIG. 9 is an exemplary block diagram illustrating a configuration of an authentication program executed by the electronic apparatus according to the embodiment.

FIG. 10 is an exemplary flowchart illustrating procedures of password setting processing performed by the electronic apparatus according to the embodiment.

FIG. 11 is an exemplary flowchart illustrating the procedures of the password authentication processing performed by the electronic apparatus according to the embodiment.

FIG. 12 is an exemplary block diagram illustrating a configuration example of a system including a server and the electronic apparatus according to the embodiment.

### DETAILED DESCRIPTION

Various embodiments will be described hereinafter with reference to the accompanying drawings.

In general, according to one embodiment, an electronic apparatus comprises a setting controller and a processor. The setting controller sets a first password corresponding to a first input method for inputting a character string, and a second password corresponding to a second input method for inputting a character string, the second input method being different from the first input method. The processor performs authentication processing for determining whether a password input by the first input method or the second input method is correct by comparing the password with a registered password. The processor determines which of the first input method and the second input method is used, and changes the registered password either to the first password or to the second password based on a result of the determination of the input method.

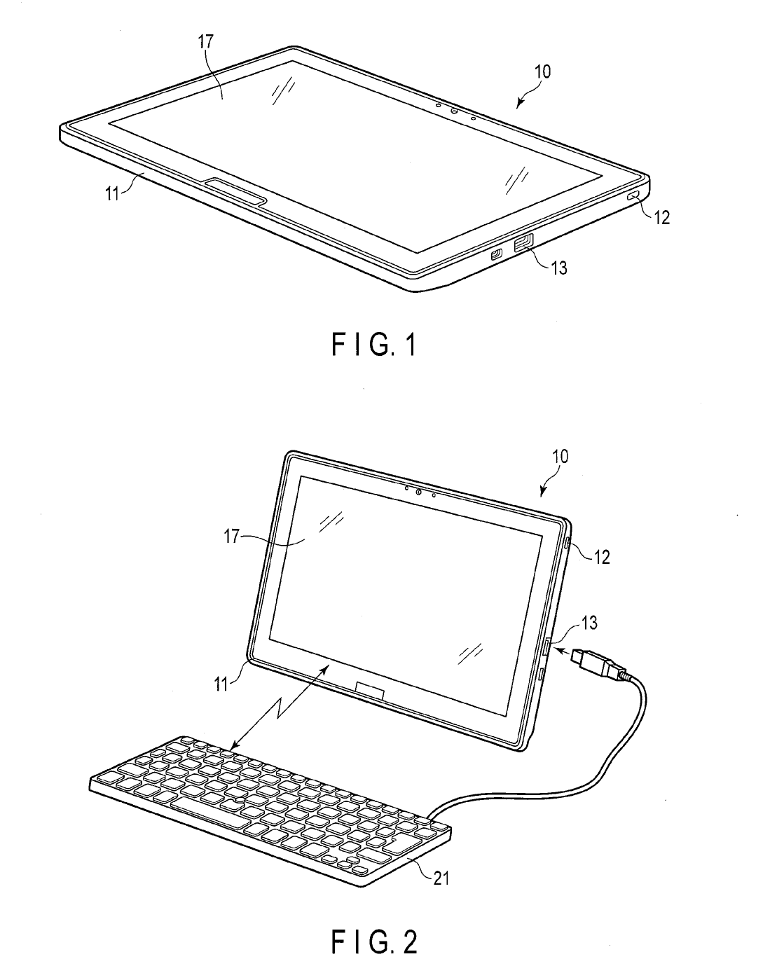

FIG. 1 is a perspective view illustrating an outer appearance of an electronic apparatus according to an embodiment. This electronic apparatus is an apparatus which can perform processing such as viewing and editing electronic documents, databases and other various digital contents. This electronic apparatus can be realized as a tablet computer, a notebook computer, a smartphone, a PDA, etc. Suppose, hereinafter, this electronic apparatus is realized as a tablet computer 10.

The tablet computer 10 is a portable electronic apparatus also called a tablet or slate computer. The tablet computer 10 comprises a main body 11 and a touchscreen display 17, as shown in FIG. 1. The touchscreen display 17 is overlapped with and attached to the upper surface of the main body 11.

The main body 11 comprises a thin box-shape housing. A power button 12, a USB port 13, etc., are arranged on a side surface of the main body 11. A flat panel display and a sensor are embedded in the touchscreen display 17. The sensor is configured to detect a contact position of a stylus or a finger on a screen of the flat panel display. For example, a capacitance type touchpanel and an electromagnetic induction type digitizer can be used as a sensor. The flat panel display may be, for example, a liquid crystal display (LCD).

The tablet computer 10 can display a software keyboard on the touchscreen display 17. The software keyboard includes a plurality of keys (software buttons) to which a plurality of key codes are assigned, respectively. The user can input desired key codes, for example, a desired character string into the computer 10 by tapping some keys on the software keyboard by the stylus or finger. Also, the tablet computer 10 can use not only the software keyboard but other various input devices such as a physical keyboard (hardware keyboard) as necessary.

FIG. 2 illustrates an example of a relationship between the tablet computer 10 and a physical keyboard (hardware keyboard) 21.

The tablet computer 10 can use the physical keyboard 21 which can be connected to the tablet computer 10 as an input device, as shown in FIG. 2. The physical keyboard 21 may be connected to the tablet computer 10 by cable. Alternatively, the physical keyboard 21 may be wirelessly connected to the tablet computer 10. A cable interface for connecting between the physical keyboard 21 and the tablet computer 10 may be, for example, USB. In this case, the physical keyboard 21 is connected to the USB port 13 of the tablet computer 10 through a USB cable. A wireless interface for connecting between the physical keyboard 21 and the tablet computer 10 may be, for example, Bluetooth®.

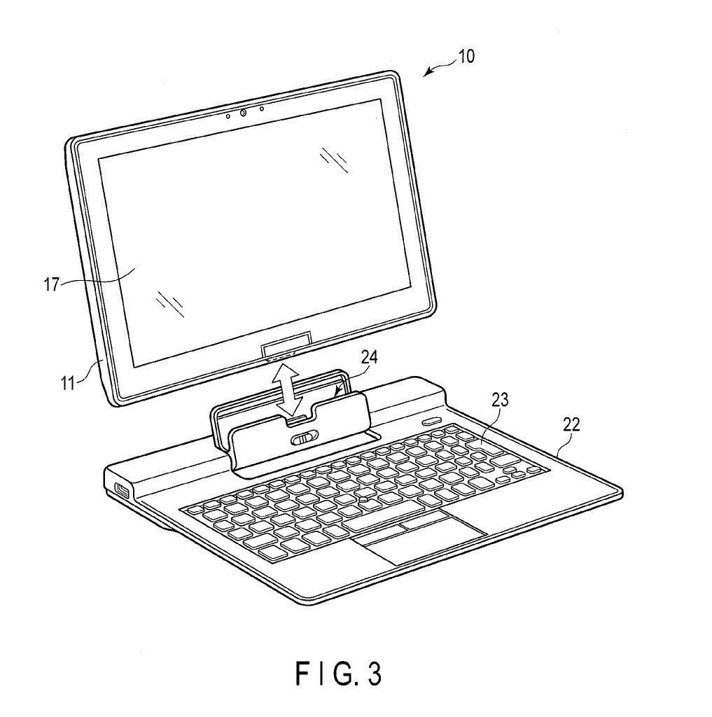

FIG. 3 illustrates another example of the relationship between the tablet computer 10 and the physical keyboard 21.

Here, suppose the tablet computer 10 is detachably attached to a keyboard dock 22. A physical keyboard 23 is arranged on a base unit of the keyboard dock 22. The main body 11 of the tablet computer 10 comprises a connector (docking port). When the tablet computer 10 is docked with the keyboard dock 22, the connector (docking port) of the main body 11 of the tablet computer 10 is connected to a connector in a hinge 24 of the keyboard dock 22. The physical keyboard 23 is electrically connected to the tablet computer 10 through the docking port.

The user can input a key code string (character string) by operating the software keyboard displayed on the touchscreen display 17. Also, the user can input the key code string (character string) by operating the physical keyboard 21 or 23.

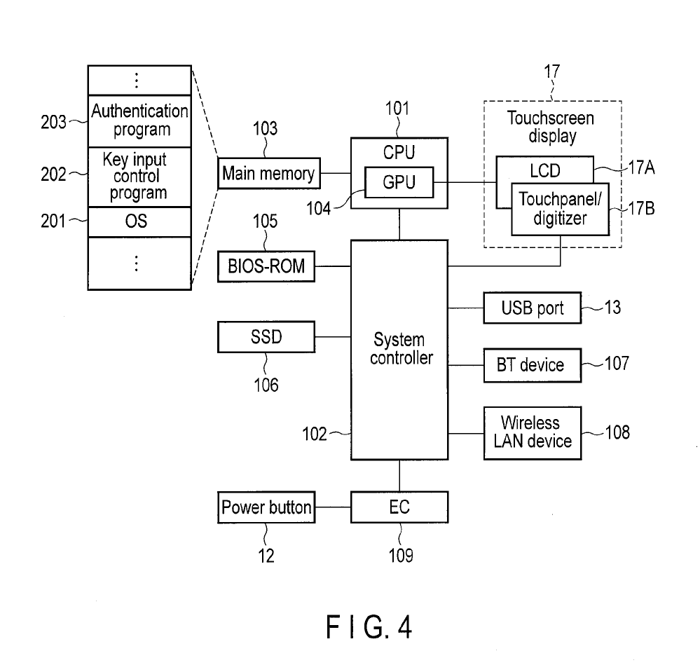

FIG. 4 illustrates a system configuration of the tablet computer 10.

As shown in FIG. 4, the tablet computer 10 comprises a CPU 101, a system controller 102, a main memory 103, a graphics processing unit (GPU) 104, a BIOS-ROM 105, a storage device 106, a BT (Bluetooth®) device 107, a wireless LAN device 108, an embedded controller (EC) 109, etc.

The CPU 101 is a processor configured to control the operation of various modules in the tablet computer 10. The CPU 101 executes various computer programs loaded from the storage device 106 such as a solid-state drive (SSD) into the main memory 103. The program executed by the CPU 101 comprises an operating system (OS) 201 and various application/utility programs. The application/utility programs comprise a key input control program 202, an authentication program 203, etc.

The key input control program 202 receives a key code from the software keyboard or physical keyboard (21 or 23), and passes the received key code to an active application program.

The authentication program 203 performs authentication processing for determining whether a password input by the user is correct or not by comparing the input password with a preset password (registered password). The authentication program 203 may be executed, for example, when access to a database or release of a screen lock is requested. When the authentication program 203 is executed, the authentication program 203 displays on the touchscreen display 17 a password input screen for prompting the user to input a password.

The authentication program 203 is designed to be compatible with a plurality of types of input methods for inputting a character string.

The plurality of types of input methods are roughly divided into an input method for inputting a password (character string) using a physical keyboard, and an input method for inputting a password (character string) using a software keyboard. Also, a plurality of types of software keyboards which can be displayed are usually present. Thus, the plurality of types of input methods may include an input method for inputting a password (character string) using a type of software keyboard and an input method for inputting a password (character string) using another type of software keyboard.

In addition, the physical keyboard includes a normal keyboard such as a 101-key keyboard and a 106-key keyboard but a keyboard with fewer keys (numeric keypad). Thus, an input method may be present for each type of physical keyboard.

In general, ease of inputting a character string differs for each input method for inputting the character string, in other words, for each type of input device to be used (physical keyboard, software keyboard, type of physical keyboard, and type of software keyboard). Thus, if a structure of using a specified password regardless of the input method to be used is adopted, a comparatively long time may be required to input a password, or a password may be incorrectly input, depending on an input environment (input method) currently used by the user.

Then, in this embodiment, the authentication program 203 has a function of individually setting a password for each input method used by the user, for example, for each type of input device used by the user.

Here, suppose a first input method for inputting a character string and a second input method for inputting a character string are present. The second input method is an input method different from the first input method. The authentication program 203 can set a first password corresponding to the first input method and a second password corresponding to the second input method in accordance with an operation by the user.

In the authentication processing, the authentication program 203 determines whether an input method used by the user for inputting a password is the first or second input method. The input method used by the user for inputting the password can be determined, for example, by detecting a type of a currently-used input device, or by detecting a type, etc., of a currently-used software keyboard.

If it is determined that the first input method is used, the authentication program 203 compares an input password with the first password corresponding to the first input method to verify the input password. On the other hand, if it is determined that the second input method is used, the authentication program 203 compares the input password with the second password corresponding to the second input method to verify the input password.

As described above, the authentication program 203 can automatically change a registered password to be compared with an input password between the first and second password in accordance with the determination result of the input method. Thus, the user can receive authentication processing using a password corresponding to a current input environment.

The CPU 101 also executes a Basic Input/Output System (BIOS) stored in the BIOS-ROM 105. The BIOS is a program for hardware control.

The system controller 102 is a device for connecting between a local bus of the CPU 101 and various components in the tablet computer 10. A memory controller for performing access control over a main memory 103 is also embedded in the system controller 102.

The GPU 104 is a display controller configured to control an LCD 17A used as a display monitor of the tablet computer 10. The GPU 104 may be embedded in the CPU 101.

A display signal generated by the GPU 104 is transmitted to the LCD 17A. The LCD 17A displays a screen image based on the display signal. A sensor 17B comprising a touchpanel or a digitizer is arranged on an upper layer of the LCD 17A.

The EC 109 is a single-chip microcomputer including an embedded controller for power management. The EC 109 has a function of powering on or off the tablet computer 10 in accordance with an operation of the power button 12 by the user.

Next, an example of some input devices which can be used by the tablet computer 10 is described.

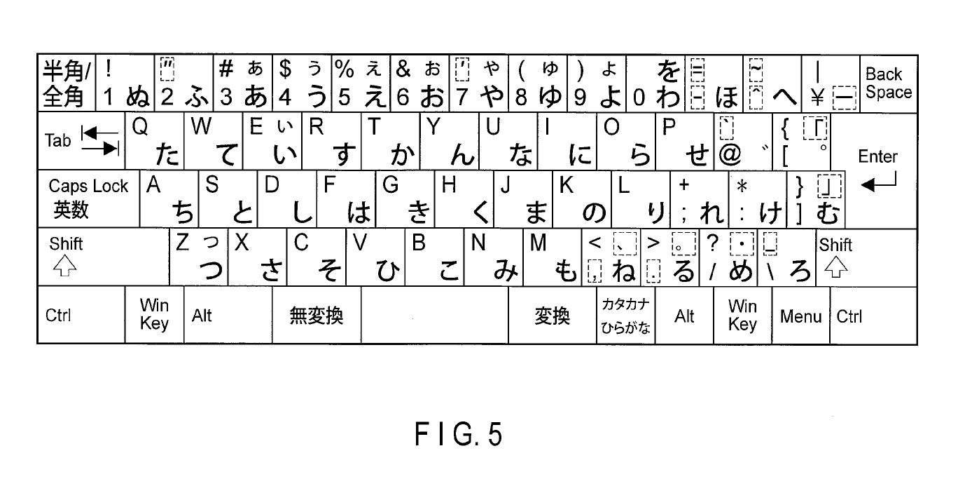

FIG. 5 illustrates an example of a physical keyboard. The physical keyboard of FIG. 5 is that of Japanese arrangement. The physical keyboard used by the user may be a keyboard of English arrangement.

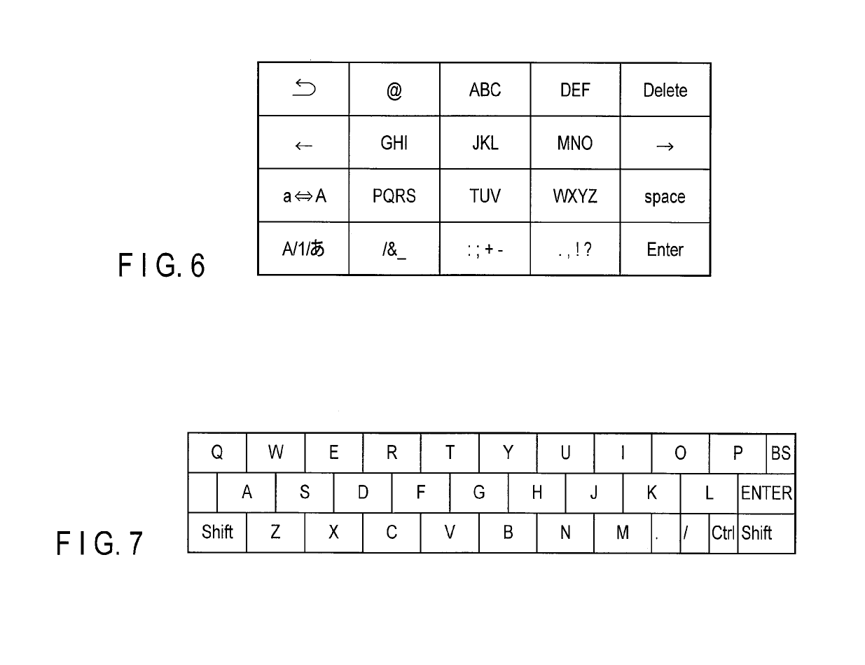

FIG. 6 illustrates an example of a software keyboard. The software keyboard of FIG. 6 is a software 10-keyboard (software numeric keypad) for multi-tap input. The software keyboard used by the user may be a software 10-keyboard (software numeric keypad) for flick input.

FIG. 7 illustrates another example of a software keyboard. The software keyboard of FIG. 7 is a software keyboard having a QWERTY layout.

As described above, ease of inputting a character string differs for each input method for inputting the character string (type of physical keyboard, type of software keyboard, etc.).

In general, for the physical keyboard, skill in typing operation such as touch typing is present, and rapid typing can be acquired by practice.

On the other hand, the software keyboard is unsuitable for inputting a long character string, and incorrect input easily occurs. Also, processing for changing input character types (letters, numbers, Japanese characters, etc.) is troublesome.

The authentication program 203 can set a password different for each input method used for password input as a registered password. Thus, for example, the user can set a password with a long character string as a password corresponding to input method enabling rapid typing (input method using the physical keyboard), and a password with a short character string as a password corresponding to another input method which is unsuitable for inputting a long character string (input method using the software keyboard). Also, different passwords can be set in accordance with the types of software keyboards (software numeric keypad [multi-tap input], software numeric keypad [flick input] and software keyboard [QWERTY]).

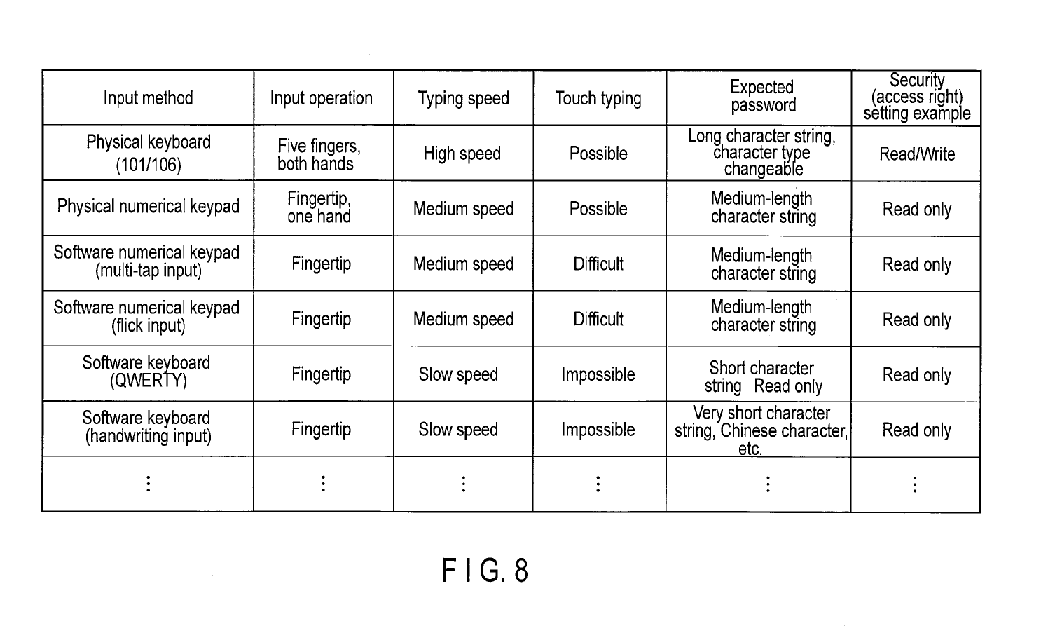

FIG. 8 illustrates an example of a password associated with each of a plurality of input methods which can be used.

Here, the following six input methods are shown as the input methods which can be used:

(1) physical keyboard (101/106 keys);

(2) physical numeric keypad;

(3) software numeric keypad (multi-tap input);

(4) software numeric keypad (flick input);

(5) software keyboard (QWERTY); and

(6) software keyboard (handwriting input).

The user can set a different password for each input method as a registered password using the authentication program 203. In the authentication processing, a registered password to be compared with an input password is automatically changed in accordance with the input method used for inputting a password.

In the authentication processing, if, for example, a password is input using a physical keyboard (101/106 keys), the input password is compared with a registered password corresponding to the physical keyboard (101/106 keys). Also, if a password is input using a software numeric keypad (multi-tap input), the input password is compared with a registered password corresponding to the software numeric keypad (multi-tap input).

In addition, in this embodiment, a security level (access right level) to be given to the user can be set for each registered password used in the authentication processing.

For example, if it is determined that an input password is a correct password matching the registered password corresponding to the physical keyboard (101/106 keys), the access right level to be given to the user is set to a first access right level at which a first function can be executed. In this case, the security level (access right level) to be given to the user to access a database may be set to a security level at which the user is allowed to both view (read) and edit (write) data in the database.

On the other hand, if it is determined that an input password is a correct password matching the registered password (medium-length password) corresponding to the software numeric keypad (multi-tap input), the access right level to be given to the user is set to a second access right level at which the execution of the first function is limited. In this case, the security level (access right level) to be given to the user to access a database may be given to a security level at which the user is allowed to merely view (read) the data in the database.

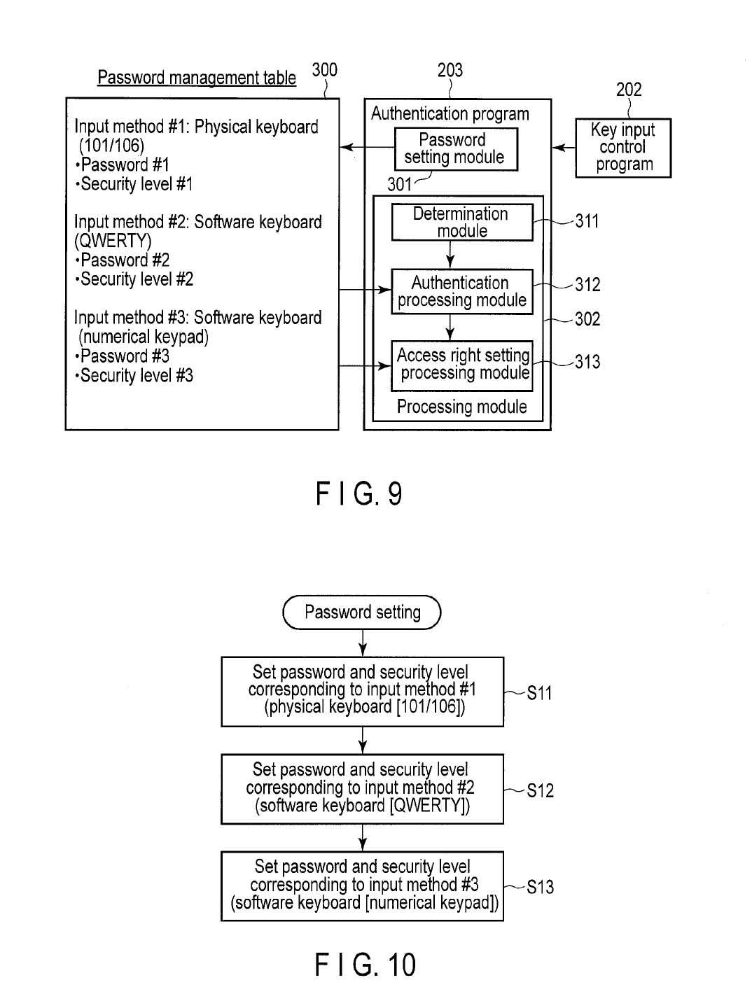

FIG. 9 illustrates a functional configuration of the authentication program 203.

The authentication program 203 includes a password setting module 301 and a processing module 302. The password setting module 301 functions as a setting controller configured to perform processing for setting a password in accordance with an operation by the user in cooperation with the CPU 101. The password setting module 301 sets a first password corresponding to a first input method for inputting a character string, and a second password corresponding to a second input method for inputting a character string on a password management table 300, the second input method being different from the first input method. It should be noted that input methods which can be used are not limited to two input methods, and at least three types of passwords corresponding to at least three input methods, respectively, can be set.

The password management table 300 is a storage area for storing a password (registered password) corresponding to each input method. Not only the passwords corresponding to input methods but a security level (access right level) corresponding to each of the input methods can be set in the password management table 300

On the password management table 300 of FIG. 9, a first password (password #1) corresponding to input method #1 is set as a registered password, and a first security level (security level #1) is set as a security level corresponding to the first password (password #1). Input method #1 may be, for example, an input method using the physical keyboard (101/106 keys).

Furthermore, in the password management table 300, a second password (password #2) corresponding to input method #2 is set as a registered password, and a second security level (security level #2) is set as a security level corresponding to the second password (password #2). Input method #2 may be, for example, an input method using a software keyboard (QWERTY).

Furthermore, in the password management table 300, a third password (password #3) corresponding to input method #3 is set as a registered password, and a third security level (security level #3) is set as a security level corresponding to the third password (password 43). Input method #3 may be, for example, an input method using a software numeric keypad (multi-tap input or flick input).

The processing module 302 functions as a processor configured to perform authentication processing for determining whether a password input by input method #1, input method #2 or input method #3 is correct or not by comparing the input password with a preset registered password in cooperation with the CPU 101. The processing module 302 comprises a determination module 311, an authentication processing module 312 and an access right setting processing module 313.

The determination module 311 determines which of input method #1, input method #2 and input method #3 is used by the user for inputting a password. The determination of the input method can be performed in cooperation with the operating system 201.

The authentication processing module 312 automatically changes a registered password to be compared with an input password between password #1, password #2 and password #3 based on the result of the determination of the input method used by the user.

That is, if the input method used by the user is input method #1, the authentication processing module 312 performs first authentication processing for determining whether the password input by the user is correct or not by comparing the input password with password #1 corresponding to input method #1. If the input method used by the user is input method #2, the authentication processing module 312 performs second authentication processing for determining whether the password input by the user is correct or not by comparing the input password with password #2 corresponding to input method #2. If the input method used by the user is input method #3, the authentication processing module 312 performs third authentication processing for determining whether the password input by the user is correct or not by comparing the input password with password #3 corresponding to input method #3.

The access right setting processing module 313 sets an access right level (security level) to be given to the user. If it is determined that the input password is a correct password matching password #1, the access right setting processing module 313 sets an access right level (security level) to be given to the user to security level #1. Also, if it is determined that the input password is a correct password matching password #2, the access right setting processing module 313 sets an access right level (security level) to be given to the user to security level #2. Also, if it is determined that the input password is a correct password matching password #3, the access right setting processing module 313 sets an access right level (security level) to be given to the user to security level #3.

The flowchart of FIG. 10 illustrates procedures of password setting processing. Here, suppose three types of passwords corresponding to input methods #1 to #3 are set.

The password setting module 301 sets password #1 corresponding to input method #1 (step S11). In step S11, a password input by the user is set in the password management table 300 as password #1 corresponding to input method #1. In step S11, the access right setting processing module 313 sets an access right level (security level) corresponding to password #1 in the password management table 300 in accordance with an operation by the user.

Next, the password setting module 301 sets password #2 corresponding to input method #2 (step S12). In step S12, a password input by the user is set in the password management table 300 as password #2 corresponding to input method #2. In step S12, the access right setting processing module 313 sets an access right level (security level) corresponding to password #2 in the password management table 300 in accordance with an operation by the user.

Next, the password setting module 301 sets password #3 corresponding to input method #3 (step S13). In step S13, a password input by the user is set in the password management table 300 as password #3 corresponding to input method #3. In step S13, the access right setting processing module 313 sets an access right level (security level) corresponding to password #3 in the password management table 300 in accordance with an operation by the user.

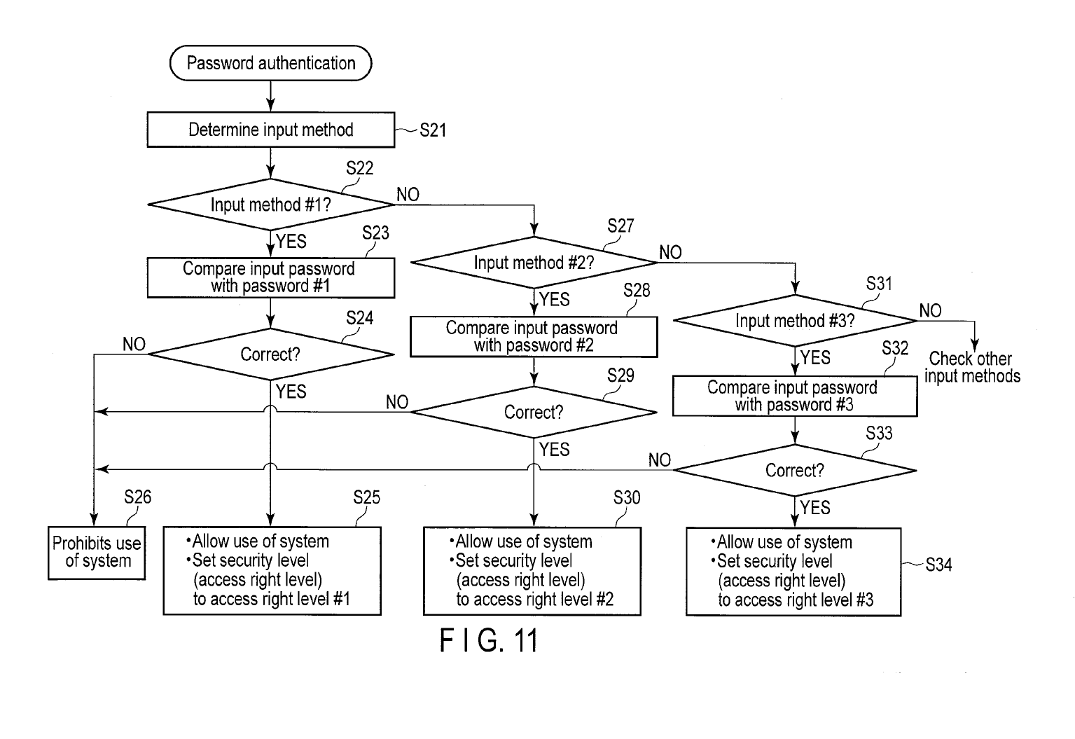

The flowchart of FIG. 11 illustrates procedures of password authentication processing.

The processing module 302 first determines a type of an input method used by the user for inputting a password (step S21).

If the input method used by the user for inputting the password is input method #1 (YES in step S22), the processing module 302 determines whether an input password is correct or not by comparing the password input by the user with password #1 corresponding to input method #1 (step S23). If it is determined that the input password is a correct password matching password #1 (YES in step S24), the processing module 302 allows the user to use a system (for example, access to database, release of screen lock, etc.), and set a security level to be given to the user to security level #1 (step S25). On the other hand, if the input password does not match password #1 (NO in step S24), the processing module 302 prohibits the user from using the system (step S26).

If the input method used by the user for inputting the password is input method #2 (YES in step S27), the processing module 302 determines whether the input password is correct or not by comparing the password input by the user with password #2 corresponding to input method #2 (step S28). If it is determined that the input password is a correct password matching password #1 (YES in step S29), the processing module 302 allows the user to use a system, and set a security level to be given to the user to security level #2 (step S30). On the other hand, if the input password does not match password #1 (NO in step S29), the processing module 302 prohibits the user from using the system (step S26).

If the input method used by the user for inputting the password is input method #3 (YES in step S31), the processing module 302 determines whether the input password is correct or not by comparing the password input by the user with password #3 corresponding to input method #3 (step S32). If it is determined that the input password is a correct password matching password #1 (YES in step S33), the processing module 302 allows the user to use a system, and sets a security level to be given to the user to security level #3 (step S34). On the other hand, if the input password does not match password #3 (NO in step S33), the processing module 302 prohibits the user from using the system (step S26).

The above description is provided on the premise that an authentication system which performs authentication processing for determining whether the input password is correct or not is present in the tablet computer 10. However, the authentication method of this embodiment including a function of changing a password to be used in the authentication processing for each input method can be applied to a system configuration in which the authentication system is present outside.

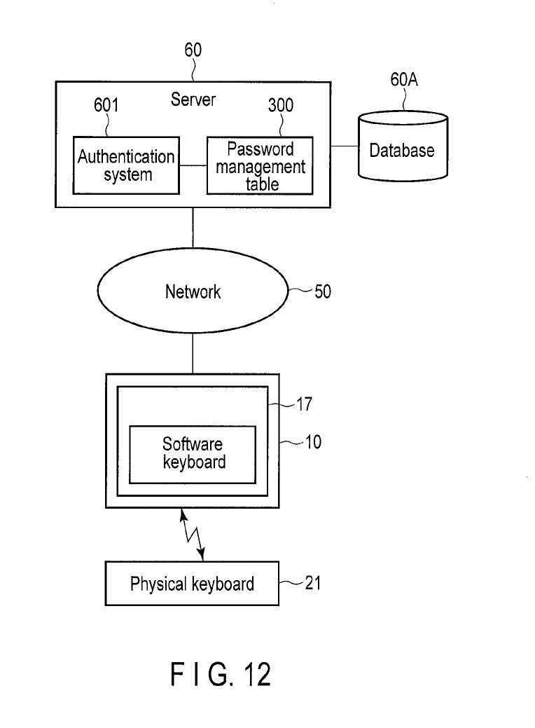

FIG. 12 is a configuration of a system including a server 60 and the tablet computer 10.

In the system of FIG. 12, an authentication system 601 is present on the server 60. The authentication system 601 is configured to execute functions of the authentication processing module 312 and the access right setting processing module 313 described in FIG. 9.

The processing module 302 of the tablet computer 10 determines an input method used by the user for inputting a password, and performs processing for causing the authentication system 601 to change a registered password to be compared with the input password between a plurality of registered passwords corresponding to a plurality of input methods in accordance with the determination result. In this case, the processing module 302 of the tablet computer 10 may transmit the determination result of the input method to the authentication system 601. The authentication system 601 changes the registered password to be compared with the input password between the plurality of registered passwords corresponding to the plurality of input methods in accordance with the determination result of the input method which is indicated from the processing module 302.

If the input method used by the user for inputting the password is input method #1, the authentication system 601 compares the password with password #1 corresponding to input method #1. Also, if the input method used by the user for inputting the password is input method #2, the authentication system 601 compares the input password with password #2 corresponding to input method #2. Also, if the input method used by the user for inputting the input password is input method #3, the authentication system 601 compares the input password with password #3 corresponding to input method #3.

Accordingly, the password to be used in the authentication processing can be changed for each input method also in the system of FIG. 12.

As described above, in this embodiment, at least the first password corresponding to the first input method for inputting a character string and the second password corresponding to the second input method for inputting a character string can be set. Whether the input method used by the user for inputting the password is the first or second input method is determined. The registered password to be compared with the input password is changed between the first password corresponding to the first input method and the second password corresponding to the second input method based on the determination result. Thus, the password to be used by the user can be automatically changed in accordance with the input method used by the user. Accordingly, the user can easily perform a password input operation, whatever input method is used, by, for example, setting a long password as a password corresponding to an input method in which a long character string can be easily input, and setting a short password as a password corresponding to an input method unsuitable to input a long character string.

It should be noted that since various types of processing in this embodiment can be realized by a computer program, an advantage similar to that of this embodiment can be easily achieved merely by installing the computer program in a usual computer through a computer-readable storage medium storing the computer program, and executing the program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a setting controller to set a first password corresponding to a first input method for inputting a character string, and a second password corresponding to a second input method for inputting a character string, the second input method being different from the first input method; and
a processor to perform authentication processing for determining whether a password input by the first input method or the second input method is correct by comparing the password with a registered password,
wherein the processor determines which of the first input method and the second input method is used, and changes the registered password either to the first password or to the second password based on a result of the determination of the input method.

2. The electronic apparatus of claim 1, wherein the first input method is for inputting a character string using a physical keyboard, and the second input method is for inputting a character string using a software keyboard.

3. The electronic apparatus of claim 1, wherein the first input method is for inputting a character string using a first type of software keyboard, and the second input method is for inputting a character string using a second type of software keyboard different from the first type of software keyboard.

4. The electronic apparatus of claim 1, wherein the processor sets an access right level to a first access right level at which a first function is executable when the input password matches the first password, and sets an access right level to a second access right level at which execution of the first function is limited when the input password matches the second password.

5. An authentication method comprising:
setting a first password corresponding to a first input method for inputting a character string, and a second password corresponding to a second input method for inputting a character string, the second input method being different from the first input method;
determining which of the first input method and the second input method is used by a user for inputting a password;
performing first authentication processing for determining whether the password is correct by comparing the password with the first password when the first input method is used; and
performing second authentication processing for determining whether the password is correct by comparing the password with the second password when the second input method.

6. The authentication method of claim 5, wherein the first input method is for inputting a character string using a physical keyboard, and the second input method is for inputting a character string using a software keyboard.

7. The authentication method of claim 5, wherein the first input method is for inputting a character string using a first type of software keyboard, and the second input method is for inputting a character string using a second type of software keyboard different from the first type of software keyboard.

8. The authentication method of claim 5, further comprising:
setting an access right level to be given to a user to a first access right level at which a first function is executable when the input password matches the first password; and
setting an access right level to be given to a user to a second access right level at which execution of the first function is limited when the input password matches the second password.

9. A computer-readable, non-transitory storage medium having stored thereon a computer program which is executable by a computer, the computer program controlling the computer to execute functions of:
setting a first password corresponding to a first input method for inputting a character string, and a second password corresponding to a second input method for inputting a character string, the second input method being different from the first input method; and
performing authentication processing for determining whether a password input by the first input method or the second input method is correct by comparing the input password with a registered password,
the performing comprising:
determining which of the first input method and the second input method is used for inputting the password; and
changing the registered password between the first password corresponding to the first input method and the second password corresponding to the second input method based on a result of the determination of the input method used by the user.

10. The storage medium of claim 9, the first input method is for inputting a character string using a physical keyboard, and the second input method is for inputting a character string using a software keyboard.

11. The storage medium of claim 9, the first input method is for inputting a character string using a first type of software keyboard, and the second input method is for inputting a character string using a second type of software keyboard different from the first type of software keyboard.

12. The storage medium of claim 9, the computer program further controlling the computer to execute functions of:
setting an access right level to be given to a user to a first access right level at which a first function is executable when the input password matches the first password; and
setting an access right level to be given to a user to a second access right level at which execution of the first function is limited when the input password matches the second password.
